(19) United States
(12) Patent Application Publication
(10) Pub. No.: US 2006/0198568 A1
(43) Pub. Date: Sep. 7, 2006

(54) Method for trasmission of signals in a circuit board and a circuit board

(75) Inventors: Joni Hietala, Viiala (FI); Tuomo Von Lerber, Helsinki (FI)

Correspondence Address: VENABLE LLP, P.O. BOX 34385, WASHINGTON, DC, 20045-9998, US

(73) Assignee: ASPOCOMP TECHNOLOGY OY, Vantaa (FI)

(21) Appl. No.: 10/562,697

(22) PCT Filed: Jun. 24, 2004
(86) PCT No.: PCT/FI04/50106

§ 371 Date: Dec. 30, 2005

(30) Foreign Application Priority Data
Jun. 30, 2003 (FI) 20035115

(51) Int. Cl. G02B 6/12

(52) U.S. Cl. 385/14

(57) ABSTRACT

A method for transmitting signals in a circuit board. At least one optical channel is formed in the circuit board, to which an optical signal is input with an optical transmitter. The optical signal input to the optical channel is received with at least one optical receiver. The optical channel is designed in such a manner that at least two focal points are formed in it. The optical transmitter is placed substantially in connection with one focal point, and the optical receiver is placed substantially in connection with another focal point.

The present invention relates to a method for transmitting signals in a circuit board, in which at least one optical channel is formed, to which an optical signal is input with an optical transmitter and the optical signal input to the optical channel is received with at least one optical receiver. The invention also relates to a circuit board, in which at least one optical channel, at least one optical transmitter in an optical connection with the optical channel, and at least one optical receiver in an optical connection with the optical channel are formed.

Circuit boards are known where one or more optical waveguides or some other corresponding optical channel is formed, where the purpose is to transmit optical signals typically from an optical transmitter to an optical receiver. In this type of circuit boards according to prior art the optical channel is typically formed substantially as an optical path of an even width between the optical transmitter and the optical receiver. The optical channel can be, for example, an optical fibre placed in the circuit board or a groove that is filled with one or more photoconductive materials. It is also known to arrange combiners in this type of optical paths, in which case the signal is branched out to these different paths and can be received with several different optical receivers. On the other hand, branching can also be used in situations where one receiver receives optical signals sent from several transmitters.

Patent U.S. Pat. No. 6,396,968 discloses a circuit board, where the optical layer is uniform, without separate waveguides. Optical transmitters and receivers are inserted in the optical layer, which are carefully aligned in pairs. Each pair operates in their own wavelength, in which case it is possible to simultaneously transmit signals between several transmitter-receiver-pairs. In this solution the optical transmitters and optical receivers are inserted in the optical layer formed within the circuit board. Since a certain wavelength range is reserved for the use of one transmitter-receiver-pair, each transmitter-receiver-pair has to be implemented with a different technique, or at least with different components, if a simultaneous signal transmission is required. The number of wavelength ranges available for use is also limited, at least for commercially available components, which, for its part, limits the number of transmitter-receiver-pairs available for use.

With the solutions according to prior art, there is, among other things, the problem that the input of an optical signal to an optical channel requires an extremely accurate alignment in order to keep the transmission losses of the signal as small as possible. Correspondingly, the optical receiver must be coupled as accurately as possible to the optical channel, so that as much of optical power as possible transfers from the optical channel to the optical receiver. In circuit boards where the division of an optical signal for several receivers is required, the difficulty is to implement the branching point so accurately that the transmission losses of the signal remain within reasonable limits and that enough optical power is transferred to each receiver.

One purpose of the present invention is to improve the prior art and to provide a method for transmitting signals in a circuit board and a circuit board, where the problems of prior art have been aimed to be eliminated. The invention is based on the idea that the optical channel formed in the circuit board is designed in such a manner that at least two focal points are optically formed in the optical channel. Each transmitter and receiver is placed in one such focal point, in which case the signal is transmitted as efficiently as possible between the optical channel and the transmitter/receiver. To put it more precisely, the method according to the present invention is primarily characterized in that the optical channel is designed in such a manner that at least two focal points are formed in it, and each optical transmitter is placed substantially in connection with one focal point and the optical receiver is placed substantially in connection with another focal point. The circuit board according to the present invention is primarily characterized in that the optical channel is designed in such a manner that it comprises at least two focal points, and that the optical transmitter is arranged to be placed substantially in connection with one focal point and the optical receiver is arranged to be placed substantially in connection with another focal point.

The present invention shows remarkable advantages over solutions of prior art. In a circuit board implemented with the method according to the invention, the transmission loss of the optical signal is decreased in comparison to the solutions of prior art, because the optical signals leaving from the optical transmitter placed in connection with one focal point are focused in the channel as accurately as possible to another focal point. A large part of the optical signal transferring in the channel is transferred to the receiver placed in connection with this other focal point. In addition, with the method according to the invention, the branching can be implemented relatively easily by forming the optical channel into such that it comprises several optical focal point pairs, and that these focal point pairs have at least one shared focal point. A transmitter and a receiver are placed in connection with this kind of a shared focal point. Thus, the optical signals leaving from the transmitter placed in connection with a shared focal point transfer to other focal points with a small loss, in which case the signal can be received in these different focal points. Correspondingly, when placing the receiver in this type of a shared focal point, signals can be sent from transmitters placed in several different focal points to this one optical receiver placed in a shared focal point. It is also possible to attach reflecting surfaces in the optical channel according to the invention, for example, in order to boost inlet coupling and/or to improve the refraction of the optical signal from the edge of the optical channel.

The operation of the invention according to the above does not depend on the structure or divergence of the source, the inlet coupling manner, nor substantially on the wavelength or the material base. The invention enables the use of both a LED and a laser source as an optical transmitter. The source can be placed in the focal point relatively freely, because the optical signals leaving the focal point drift to another focal point relatively efficiently substantially independently of which direction the optical signals radiate from the transmitter.

### DESCRIPTION OF THE DRAWINGS

In the following, the invention will be described in more detail with reference to the appended drawings, in which

FIG. 1 shows a top view of a circuit board according to an advantageous embodiment of the invention,

FIG. 2a shows a circuit board according to FIG. 1 in a simplified cross section at the location of an optical transmitter and an optical receiver placed in an optical channel,

FIG. 2b shows a cross section of the circuit board according to FIG. 1, where an optical transmitter and an optical receiver are placed on the surface of the circuit board,

FIG. 3 shows a top view of a circuit board according to another advantageous embodiment of the invention, and

FIG. 4 shows a top view of a circuit board according to a third advantageous embodiment of the invention.

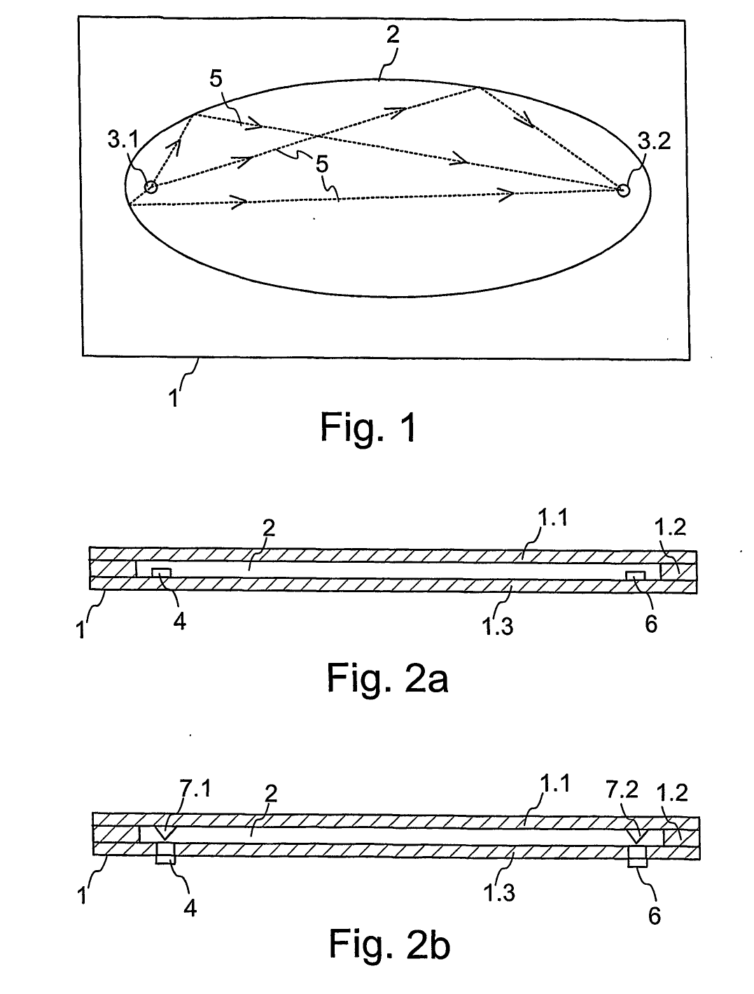

FIG. 1 shows a top view of the circuit board according to an advantageous embodiment of the invention. This circuit board 1 comprises one optical channel 2, which is designed in such a manner that it comprises two optical focal points 3. An optical transmitter 4 is placed at the location of the first focal point 3.1 of these (FIG. 2a). The optical signal formed by this optical transmitter 4 radiates from the transmitter laterally, i.e. in this case in the direction of the main level of the optical channel of the circuit board. Since the optical transmitter 4 is placed in the first focal point 3.1, at the same time it means that substantially all of the optical signal radiating from the optical transmitter is directed at a certain direction in the optical channel. This is not substantially affected by which direction the signal of the optical transmitter leaves to. However, all the possible radiation directions do not necessarily cause the reflection of the beam from the edge of the optical channel, if the angle of incidence of the beam is larger than the critical angle of the so-called total reflection. However, if the edge of the optical channel (i.e. the surface of the optical channel perpendicular to the main level) is formed as a reflecting, e.g. a mirror surface, all the beams reflect from the edge. Some routes of the optical signal are marked with arrows 5 in FIG. 1. The second focal point 3.2 is placed in such a manner that the first and second focal points form a kind of a focal point pair. In connection with this invention this means that the optical signal leaving from either focal point drifts to the other focal point substantially independently of the angle of departure the optical signal has in relation to the optical channel in the main level of the optical channel 2. This main level of the optical channel refers here to that level, which is substantially parallel to the level surface of the circuit board, because the optical layer is formed in the circuit board.

FIG. 2 shows in a simplified cross section the circuit board 1, in connection with which the optical channel 2 according to the invention is formed. The optical channel 2 is in this example placed in one mid layer 1.2 of the circuit board, but it is obvious that the optical channel may also be formed, for example, in the surface layer 1.1 or base layer 1.3 of the circuit board. For clarity, conductive patterns or conductive layers have not been marked in the appended figures.

The optical receiver 6 placed in the second focal point 3.2 receives the optical signals transmitted in the optical channel and modifies them into electric signals, which can be further transmitted to other electronics (not shown) for further processing.

FIG. 2b presents in a cross-section an embodiment of the circuit board according to FIG. 1, where the optical transmitter 4 and the optical receiver 6 have not been placed in the optical channel, but at the location of the focal point of the surface layer of the circuit board 1. Thus, a lead-in is formed advantageously in the surface layer of the circuit board in such a manner that the optical signal sent by the optical transmitter 4 can be led to the first focal point 3.1 and correspondingly from the second optical focal point 3.2 the optical signals can be led to the optical receiver 6. In this advantageous embodiment, beam inverters 7.1, 7.2 have been formed at the location of focal points in the optical channel, with which the signals coming to the first focal point from the optical transmitter 4 are inverted substantially to the direction of the main level of the optical channel and correspondingly the signals coming to the second focal point from the optical channel are inverted towards the optical receiver 6. The beam inverters 7.1, 7.2 are formed, for example, in the form of a circular cone or a wedge, but also other forms or, for example, diffractive surface structures can be used.

The optical channel 2 of FIG. 1 is formed substantially in the form of a ellipse. Thus, said focal point pair 3.1, 3.2 is formed onto the great axis of the ellipse. The height and width of the ellipse, i.e. the length of the small axis and the great axis are selected as ones best suitable for each application. This is affected, among other things, by how much space there is available for use on the circuit board 1 for designing the optical channel 2, and also by how far from each other the optical transmitter 4 and the optical receiver 6 are intended to be placed. In some cases the optical transmitter 4 and the optical receiver 6 can be placed relatively freely, in which case they are not in a dominant position for the design of the optical channel.

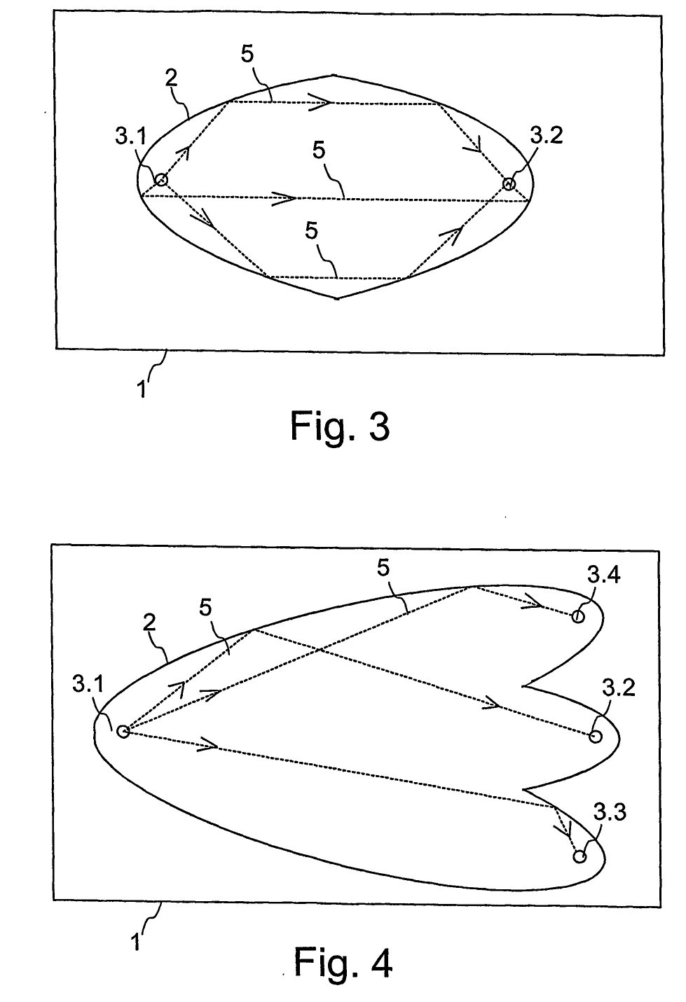

It should be mentioned here that an ellipse is not the only possible form of the optical channel 2, but also other geometrical forms may be used in connection with the present invention. As an example can be mentioned a parabola form, in which case the optical channel 2 is designed into such that there are at least two parabolas, as presented in FIG. 3. Thus, the opening directions of the parabolas are directed towards each other in such a manner that the optical signals leaving from the focal point of the first parabola are directed to the focal point of the second parabola. As is known, the beams leaving from the focal point of the parabola are directed substantially in a parallel manner to the opening direction of the parabola. Thus, the parabola form in connection with the receiver is directed preferably in such a manner that the opening direction is substantially opposite to the opening direction of the first parabola. This arrangement enables as efficient as possible direction of optical signals to the focal point of the second parabola.

FIG. 4 shows a third advantageous circuit board 1 in which the invention is applied. In this circuit board 1 there are more than two focal points 3. Of these, the first focal point 3.1 is intended for the optical transmitter 4 and the other focal points 3.2, 3.3, 3.4 are intended for the optical receivers 6. The optical channel 2 mainly follows an ellipse form in the vicinity of each focal point. In this embodiment the optical channel can be thought to be composed of three ellipse forms in such a manner that these three ellipses share one focal point 3.1 and a second focal point 3.2, 3.3, 3.4 is separate from other focal points. Thus, the optical transmitter 4 placed in the shared focal point 3.1 sends optical signals, which are directed to different focal points, where the receivers placed in them can receive the sent optical signals. It is, however, clear that there can be two or even more than three ellipse forms.

In connection with the optical circuit board according to the invention it is possible to implement the typical circuitry as well. Also, the circuit board layers possibly existing above or below the optical channel 2 can be utilized in order to implement electric couplings. In some cases it is possible to form a circuitry pattern directly on the surface of the optical channel 2.

The optical channel 2 can be formed in several different ways, depending on the application. For example, the mid-layer 1.2 of the circuit board can be designed in such a manner that a hole is made in the mid-layer 1.2, the form of which is the form desired for the optical channel. This mid-layer 1.2 can be attached, for example, on top of the lower, i.e. bottom layer 1.3, after which in the hole of the mid-layer 1.2 is placed a piece of a photoconductive (translucent) matter, which is substantially planar in one direction. This piece is designed to fit the hole in the mid-layer 1.2 of the circuit board. One other possibility is that mass in a liquid or other fluent condition is directed to the hole in the mid-layer 1.2, which when solidifying forms an optical channel 2 of a desired design.

In connection with the circuit board according to the invention, it is possible to use several different optical transmitters 4 and optical receivers 6. As an advantageous example, a light emitting diode can be mentioned, which is well suited as an optical transmitter 4. Even if the optical transmitter 4 would have a great divergence, a great deal of the radiation is focused to another focal point, in connection with which the optical receiver 6 is located. As was already stated earlier in this description, this is because, for example, that the radiation direction of the optical transmitter 4 placed in the optical channel 2 according to the invention is not very significant, because the deflection of the optical signal taking place at the edge of the optical channel takes place in such a manner that the angle of departure is substantially the same as the angle of incidence. The design of the edge of the optical channel 2 follows as closely as possible such a curve form where there are at least two focal points in such a manner that the beams leaving from one focal point are directed to another focal point by means of one or more reflections.

It will be obvious that the present invention is not limited solely to the above-presented embodiments but it can be modified within the scope of the appended claims.

1-13. (canceled)

14. A method for transmitting signals in a circuit board, the method comprising:
forming at least one optical channel, to which an optical signal is input by means of an optical transmitter and the optical signal input to the optical channel is received with at least one optical receiver;
designing the optical channel in such a manner that at least two focal points are formed in it;
placing the optical transmitter substantially in connection with one focal point; and
placing the optical receiver substantially in connection with a second focal point.

15. The method according to claim 14, further comprising:
designing the optical channel substantially in the form of an ellipse.

16. The method according to claim 14, further comprising:
designing the optical channel is designed substantially in the form of two opposite parabolas, wherein the opening directions of the parabola forms are directed towards each other.

17. The method according to claim 14, further comprising:
designing the optical channel by forming at least two ellipse forms in such a manner that each ellipse form has one shared focal point, wherein the second focal point of each ellipse form is separate from other focal points.

18. The method according to the claim 14, further comprising:
forming at least one mid-layer in the circuit board; and
placing the optical channel in the mid-layer of the circuit board.

19. A circuit board, comprising:
at least one optical channel comprising at least two focal points;
at least one optical transmitter in an optical connection with the optical channel; and
at least one optical receiver in an optical connection with the optical channel;
wherein the optical transmitter is placed substantially in connection with one focal point, and
the optical receiver is placed substantially in connection with one other focal point.

20. The circuit board according to claim 19, wherein the optical channel is substantially in the form of an ellipse.

21. The circuit board according to claim 19, wherein the optical channel is substantially in the form of two opposite parabolas, each parabola having an opening direction, and wherein the opening directions of the parabola forms are directed towards each other.

22. The circuit board according to claim 19, wherein the optical channel comprises at least two ellipse forms in such a manner that each ellipse form has one shared focal point, wherein the second focal point of each ellipse form is separate from other focal points.

23. The circuit board according to the claim 19, further comprising:
at least one mid-layer in the circuit board comprising said optical channel.

24. The circuit board according to the claim 19, wherein the optical transmitter is a strongly diverging light emitting diode.

25. The circuit board according to claim 24, wherein the optical transmitter is an RC-LED.

26. The circuit board according to the claim 19, wherein the optical transmitter is placed in the optical channel at the location of the first focal point, and wherein the optical receiver is placed in the optical channel at the location of the second focal point.

27. The circuit board according to the claim 19, wherein the optical transmitter is placed on the surface of the circuit board at the location of the first focal point, and wherein the optical channel comprises:
a first beam inverter in the first focal point to invert the signals directed from the optical transmitter to the first focal point substantially to the direction of the main level of the optical channel; and
a second beam inverter in the second focal point to invert the signals coming from the optical channel to the second focal point towards the optical receiver;
wherein the optical receiver is placed on the surface of the circuit board at the location of the second focal point.
